(19) United States
(12) Patent Application Publication
(10) Pub. No.: US 2002/0033893 A1
(43) Pub. Date: Mar. 21, 2002

(54) Method and apparatus for generating images

(76) Inventor: Thomas Hagen, Muenchen (DE)

Correspondence Address: Karl F. Milde, Jr., Esq., MILDE, HOFFBERG & MACKLIN, L.L.P., Suite 460, 10 Bank Street, White Plains, NY, 10606, US

(21) Appl. No.: 09/948,397

(22) Filed: Sep. 7, 2001

(30) Foreign Application Priority Data
Sep. 20, 2000 (DE) 100 46 666.4

(51) Int. Cl. H04N 3/14; H04N 5/335

(52) U.S. Cl. 348/311

(57) ABSTRACT

Apparatus (10) for generating images includes a receiving device (1), a control device (7) and an output device (9). Image data, received by the receiving device (1), contains the image information of several images (B1 to B4; B5 to B9) of a common image production order. The image information, transferred to the output device (9), is output onto recording material. The sequence for transferring the respective image data of images (B1 to B4; B5 to B9) of the common order to the output device (9) is specified in accordance with at least one prescribed criterion set by the control device (7).

### BACKGROUND OF THE INVENTION

The present invention relates to a method and apparatus for generating images. The apparatus for producing images includes a receiving device, a control device and an output device. Image data, received by the receiving device, contains the image information of several images of a common image production order. The image information, transferred to the output device, is output onto recording material.

Such devices and methods are used, among other places, in large-scale laboratories, where photographic images are produced and generated. Particularly, photographic films containing numerous image negatives serve as input media that contain the image information of images. In large-scale labs, typically continuous-mode machines are used for generating and producing images. Such machines process in a strip-shape both the photographic film and the photographic paper onto which the image information is exposed and recorded. For example, exposure of the image information contained in the film negatives onto photographic recording material such as photographic paper is carried out in photographic printers such as, for example, the AGFA MSP or the AGFA MSP DIMAX. Both printers are continuous-mode machines. For individual films to be processed in such continuous-mode machines, a film strip must be made that combines a multitude of films to one film strip. The film strip is coiled into a roll of film. Such a film roll remains connected during the entire process for generating the photographic images, and is only divided into the individual orders—that is, the individual films—during the final processing step. During final processing, it is very important that all components that are assigned to one single production order are correctly arranged together. Such components of an individual order may be the order pocket, the film, the produced image prints and an index print, for example.

To assemble such film rolls, large-scale labs typically perform a pre-sorting of the received films. Criteria for such pre-sorting may be order-specific selection options for the customer who can select between various alternatives for producing and generating images. For example, the reproduced images may be generated in different formats. Furthermore, different paper varieties are available that may, in particular, feature different surfaces (matte or glossy). Pre-sorting of the films that belong to the various orders is based on the customer's selection from these options. This can avoid continuous changes of the printer configuration. Such a reconfiguration of the printer would create downtime, for example. The sequence of the images within an order and the sequence of the orders are clearly specified by the run direction of the photographic film and the photographic paper. Changing this sequence is possible only with considerable effort; for example, multiple reciprocating spooling of the film roll and the associated performance loss in producing recorded images.

Some time ago, new structures for large-scale lab operations became known. For example, one such structure is described in the published European patent application EP 0 893 907 Al. According to this disclosure, several receiving devices for receiving the image data that contains the image information of several images can be linked via a so-called “bus” to several output devices for outputting image information onto recording material. The image data received by the receiving devices can be transferred to one of the output devices via the bus, based on the order-specific accompanying data that is provided to the known system for generating images together with the input media. To this end, a control device that controls the data flow from the receiving means to the output means based on the order, and corresponding to the accompanying data, is connected to the bus. With this known system, only a transfer of image data to an output means according to the orders is exclusively provided.

### SUMMARY OF THE INVENTION

It is the principal object of the present invention to provide both an apparatus and a method for generating images which increases the flexibility in generating images in a technically simple manner.

This object, as well as other objects which will become apparent from the discussion that follows, are achieved, in accordance with the present invention, by providing a method and apparatus in which the sequence of the images of the common production order is determined for the transfer of the respective image data of such images, for outputting the image information onto the recording material, in dependence upon at least one prescribed criterion. This determined sequence of the images is different from the sequence of the images in which the respective image data of the images has been received.

According to the present invention, in order to transfer the image data of images of an image production order to the output device, it is possible to perform a determining or sorting of the image sequence within the common order corresponding to the prescribed criterion. Here, the determining or sorting of the image sequence is advantageously carried out prior to the transfer of the respective image data of the images to the output means. In this manner, the effort for sorting the individual images of the order can be kept to a minimum during final processing. Furthermore, the customer can advantageously be provided with an image generation order with generated images that is improved with regard to handling versus ordered as provided previously.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a block diagram of a first preferred embodiment of a system for generating images according to the invention.

FIG. 2 is a block diagram of a second preferred embodiment of a system for generating images according to the invention.

FIG. 3 is a schematic diagram of a preferred embodiment of the system as set forth in FIG. 1 which can be used to specify the sequence for accessing stored image data.

Figs. 4A and 4B are schematic diagrams of a preferred embodiment of the system as set forth in FIG. 2, which is used to perform a successive interim storing of image data according to a previously specified sequence in a memory.

### DESCRIPTION OF THE PREFERRED EMBODIMENTS

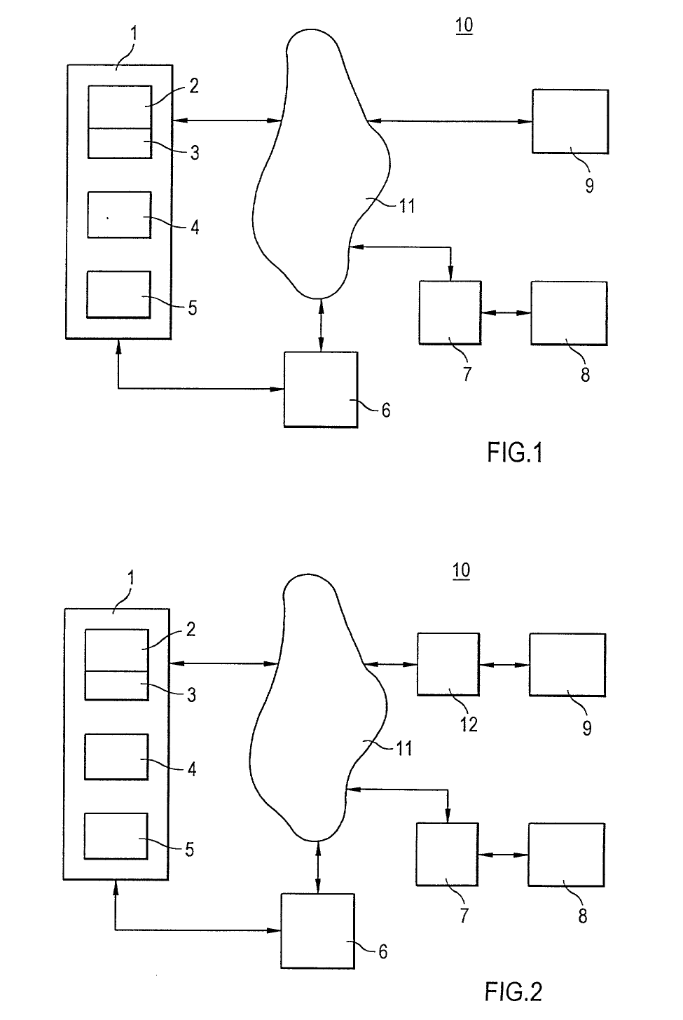

The preferred embodiments of the present invention will now be described with reference to FIGS. 1-4 of the drawings. Identical elements in the various figures are designated with the same reference numerals.

FIG. 1 shows a system 10 according to the invention for generating and producing images. Here, the system 10 is a so-called photo-finishing lab where photographic image generation orders are processed. Based on the system 10, it is possible to process image data that contains the image information of several images such that the image information can be exposed onto recording material, that is, photographic paper. However, other recording materials, such as, for example, paper that is capable of receiving ink, can be used as recording material as well. The image information can be supplied to the system 10 in varying ways. For this purpose, the system 10 can process several input media that are used to provide the system 10 with the image information of the images of the image generation order. Such input media can be photographic film, for example, but also other electronic storage media such as memory cards or chip cards, for example. It is also possible to provide the system 10 with image data directly via a public communication network such as the Internet, for example.

The system 10 includes a receiving means 1 that is used to receive image data of images of a common image generation order. The receiving means 1 includes a film scanner 2 that is used to read photographic film and to determine the image information of the individual image negatives contained on this photographic film and that can generate image data corresponding to this image information. Assigned to the film scanner 2 is an input station 3 for inputting accompanying information that is assigned to the films that are read by the film scanner 2. The accompanying information may be, for example, order-specific information that describes, for example, the type, that is in particular, the format and the surface of the photographic paper. However, it is also possible that the accompanying information that can be entered at the input means 3 contains special information based on which sorting of the images within a certain image generation order is to be carried out. Such accompanying information for sorting the images within a certain image generation order can, for example, be specified directly by the customer, that has ordered the image generation order, or it can come from the photo shop, where the customer has placed the order and from where the order is then passed on to the operator of the system 10.

To read the memory cards that contain image data with image information of the images, the receiving means 1 includes a memory card reader 4. The memory card reader 4 can be provided with a memory card that contains the image data. This image data is then read and acquired by the memory card reader 4. In addition to the image data, accompanying information may be stored on the memory card as well. This accompanying information may contain information about sorting the images within the image generation order. Furthermore, the receiving means 1 includes an interface 5 that can be used to receive image data and data with accompanying information from a network. Here, the interface 5 is designed such that the image data can be received from the Internet.

Furthermore, the system 10 includes an image data memory 6, where the image data received or determined from the film scanner 2, the memory card reader 4 or the interface 5 is stored. The image data memory 6 is connected to a network 11 such that the image data stored at the image data memory 6 can be transported across the network 11. A printer 9 is used to output the image information of the images of the image generation order onto photographic paper. The printer 9 is connected to the network 11 as well, and can, thus, receive image data that is provided by the image data memory 6. Here, the printer 9 is a digital laser exposure device whose laser beams are modulated based on the image data transferred to the printer 9 such that the corresponding image information is generated on the photographic paper. However, it is also possible to use other types of printers such as ink-jet printers, for example, that place ink onto paper suitable for this purpose.

Furthermore, the system 10 includes a control means 7 that is connected to the network 11 as well. This control means 7 in particular is used to control the image data transfer from the image data memory 6 to the printer 9. The control means 7 is designed such that it specifies the sequence of the respective images of the image generation order for transfer to the printer 9. The specification of the sequence is carried out by the control means 7 based on at least one specified criterion. Such criteria may be contained in the accompanying information received by the receiving means 1, as described above. However, it is also possible that such criteria are already specified by the system 10. For this purpose, the control means 7 is here connected with a memory 8, where certain criteria for specifying the transfer sequence of the image data to the printer 9 are stored. Such criteria that are stored in the memory 8 may be determined, for example, specific to each shop. A certain shop that sends its orders to the system 10 in order to have images generated and produced can thus specify that the images of this order are sorted in a particular sequence. Using the accompanying information that is provided to the system 10 for the individual orders, information regarding the shop that has sent the order to the system 10 may be present. If this information is recognized by the control means, it will call the criteria stored in the memory 8 for this shop and will sort the image data of the images of the order correspondingly.

The following criteria may, for example, be prescribed for specifying the sequence in which the image data of the images are transferred to the printer 9 and/or for sorting the image data of the images of a particular order:

Regardless of the run direction of any photographic film (e.g., small picture or APS film) through the film scanner 2, the first image of an order shall always be transferred first to the printer 9 for exposure. The images with the subsequent image numbers of the film follow corresponding to their sequence on the film. Thus, the images of the film can—if necessary or desired—be electronically “re-coiled”.

The images of the film are sorted in chronological sequence, that is, in the sequence of taking the respective pictures. This can be particularly advantageous, especially with APS films.

APS images can be photographed in three different formats, Classic, High and Panorama. These formats are marked on the APS films such that they can be recognized by the receiving means. A criterion may be that the images of the APS film are sorted corresponding to their formats. The Classic formats may be transferred to the printer 9 before the High formats and these in turn before the Panorama formats. This can simplify the processing and packaging after the generation of the images. Similar criteria can be established for other film formats, such as small picture films.

If several copies are to be generated from the individual images of a certain order, it is possible to initially transfer one complete set of image data of the images to be generated to the printer 9 before it generates the next set of the images of this order. For example, if an order contains the images X, Y and Z, that are each to be generated three times, it is possible in a simple manner to output three entire sets with the three images successively onto the photographic paper instead of a triple exposure of the individual images one after another, that is, an exposure X,X,X,Y,Y,Y,Z,Z,Z. Thus, the order is generated in the sequence X,Y,Z,X,Y,Z,X,Y,Z. The customer does not need to sort the individual image sets, instead, he already receives a correspondingly sorted order from the shop.

FIG. 2 shows a second preferred embodiment of the system 10 according to the invention for generating images. As set forth in FIG. 2, the system 10 includes an additional interim memory 12 between the network 11 and the printer 9. This interim memory 12 is used for interim storage of the image data after it has been called from the image data memory 6 by the control means 7. Memory 12 stores the image data of the images that are to be exposed onto photographic paper by the printer 9. The memory 12 can be designed as a so-called FiFo (First-in-First-out) memory. Thus, the image data of the individual images is stored in the memory 12 exactly in the sequence in which it is to be exposed by the printer 9 onto photographic paper. The image data that is input into the FiFo memory first is also output first from the memory 12 and transferred to the printer 9. In this case, the distribution of the image data from the image data memory 6 to the printer 9 is particularly simple and can be carried out without regard to a particular time. In particular, image data of images that is to be exposed and generated several times based on the accompanying information only needs to be transferred once via the network 11 to the memory 12. The image data can then be multiplied in the memory for multiple exposures. This limits the data volume that needs to be transferred across the network 11.

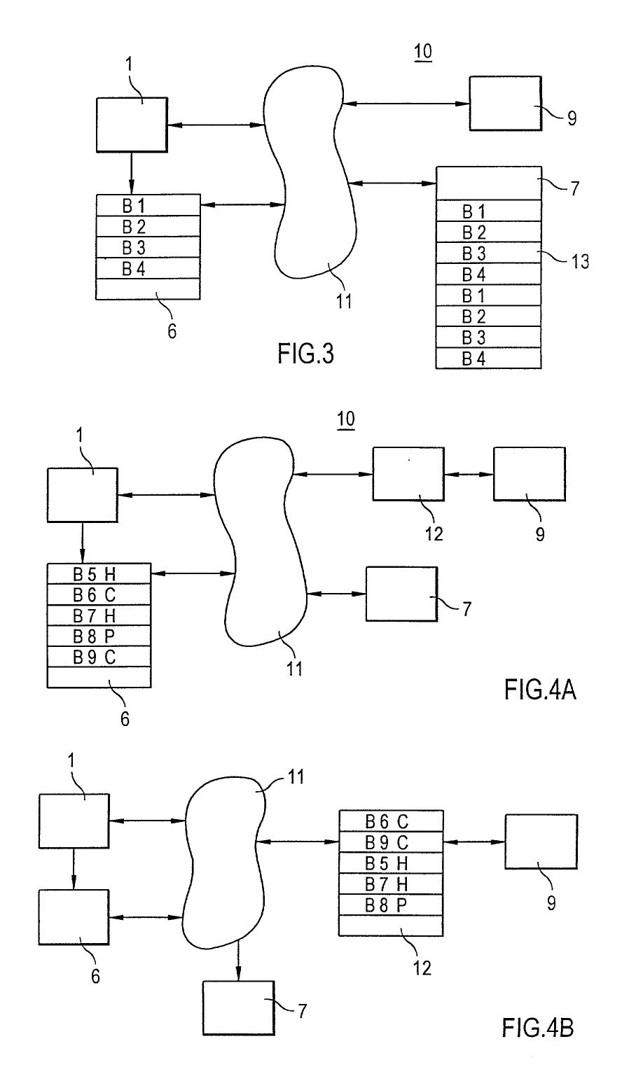

FIG. 3 shows an example of how an access sequence can be established based on the system 10 for generating images described in FIG. 1, in order to transfer image data of images of a certain order that is stored in the image data memory 6 via the network 10 to the printer 9. To this end, the control means 7 contains a memory 13 where a list can be stored that specifies the access sequence to the image data stored in the image data memory 6. In the present example as set forth in FIG. 3, the image data of four images B1, B2, B3 and B4 is stored in the image data memory 6. These four images stem from a common image generation order. The customer, who placed this order at a photo shop, specified that he would like all four images B1 to B4 in duplicate. The image information of the individual images B1 to B4 must, therefore, each be exposed twice onto photographic paper by the printer 9. Thus, the access sequence for the image data of the images B1 to B4 stored in the image data memory is specified in the memory 13 of the control means 7. In the present case, this access sequence is: B1, B2, B3, B4, B1, B2, B3, B4. This means that the image data B1 to B4 is each called twice from the image data memory 6 in order to transfer it to the printer 9. First, an entire image data set with the image data of the images B1 to B4 is transferred successively to the printer 9, before, based on the access sequence stored in the memory 13, an additional, second image data set with the image data of the images B1 to B4 is transferred via the network 10 to the printer 9. Thus, the printer 9 based on the access sequence stored in the memory 13 exposes successively the image information of the images B1 to B4 and then again the image information of the images B1 to B4 onto photographic paper.

FIGS. 4A and 4B show an example of how, based on the system 10 as set forth in FIG. 2, the sequence for transferring image data of images to the printer 9 can be specified. As already described based on the second exemplary embodiment as set forth in FIG. 2, an interim memory 12 is located between the network 11 and the printer 9. FIG. 4A shows that image data of five images, B5H, B6C, B7H, B8P and B9C is stored in the image data memory 6. These images B5 to B9 stem from a common order, where an APS film has been supplied to the system 10. This APS film has been read by the film scanner (FIG. 1) of the receiving means 1, and the obtained image data has been supplied to the image data memory 6. The letters H, C and P following the designations of the individual images B5 to B9 indicate the APC formats in which the images B5 to B9 shall be generated. H means High format, C means Classic format and P means Panorama format. Based on accompanying information that is added to the APS order, it is specified that the individual images of the order are to be sorted according to their APS format. The Classic formats shall be exposed first onto photographic paper by the printer 9, then the High formats and finally the Panorama formats. To this end, the control means 7 specifies the transfer sequence for the respective image data of the images B5 to B9 in order to subsequently carry out the transfer of the image data to the interim memory 12. Thus, this transfer to the interim memory is carried out according to the desired sorting within this order.

FIG. 4B shows the system 10 and in particular the interim memory 12 after the transfer of the image data from the image data memory 6 to the interim memory 12. Here as well, the interim memory 12 is a so-called FiFo memory. According to the desired format sorting, the image data of the images B5 to B9 has been transferred to the FiFo memory 12 in the following sequence: B6C, B9C, B5H, B7H, B8P. The image data for generating the individual images is transferred in this sequence to the printer 9.

There has thus been shown and described a novel method and apparatus for generating images which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. Apparatus for generating images comprising, in combination:
(a) receiving means for receiving image data containing the image information of a plurality of images (B1 to B4; B5 to B9) for a common image production order;
(b) output means for outputting the image information of said plurality of images onto recording material corresponding to the image data that is transferred to the output means and that contains the image information; and
(c) a control means for specifying a sequence of the images (B1 to B4; B5 to B9) of the common order for transferring the respective image data of the images (B1 to B4; B5 to B9) to the output means in dependence upon at least one prescribed criterion, wherein this specified sequence of the images is different from the sequence of the images (B1 to B4; B5 to B9) in which the respective image data of the images (B1 to B4; B5 to B9) has been received by the receiving means.

2. The apparatus set forth in claim 1, further comprising a memory for storing image data with the image information of the images of the common production order, wherein the control means controls a sequential storing of the respective image data of the images (B5 to B9) of the common order corresponding to the sequence specified in the memory.

3. The apparatus as set forth in claim 1, further comprising a memory for storing image data with the image information of the images (B1 to B4) of the common production order, wherein the control means accesses the image data of the images (B1 to B4) corresponding to the specified sequence.

4. The apparatus set forth in claim 1, further comprising an additional memory for storing the at least one prescribed criterion, wherein this at least one prescribed criterion can be retrieved in dependence upon accompanying information that is assigned to the common production order.

5. In a method for generating images, comprising the steps of:
(a) receiving image data containing the image information of several images (B1 to B4; B5 to B9) of a common image production order; and
(b) outputting the image information of the several images (B1 to B4; B5 to B9) onto recording material corresponding to transferred image data that contains the image information;
the improvement wherein
the sequence of the images (B1 to B4; B5 to B9) of the common production order is determined., for the transfer of the respective image data of the images (B1 to B4; B5 to B9), for outputting the image information onto the recording material, in dependence upon at least one prescribed criterion, and wherein this determined sequence of the images is different from the sequence of the images (B1 to B4; B5 to B9) in which the respective image data of the images (B1 to B4; B5 to B9) has been received.
